(19) United States
(12) Patent Application Publication
(10) Pub. No.: US 2013/0214942 A1
(43) Pub. Date: Aug. 22, 2013

(54) Man Overboard Detection, Tracking and Recovery

(71) Applicant: Stephen Howard Joss, Houston, TX (US)

(72) Inventor: Stephen Howard Joss, Houston, TX (US)

(21) Appl. No.: 13/773,243

(22) Filed: Feb. 21, 2013

Related U.S. Application Data
(60) Provisional application No. 61/601,365, filed on Feb. 21, 2012.

(51) Int. Cl. G08B 21/08

(52) U.S. Cl. CPC G08B 21/088
USPC 340/984

(57) ABSTRACT

The disclosure relates to systems, methods and apparatus for member or man overboard detection, tracking and recovery used for analyzing conditions on and/or around a ship or vessel located on a body or water. The member overboard detection, tracking and recovery system generally includes the ship, members of the ship, transmitting device, a ship based member overboard detection system, a member overboard (when in the detection, tracking and recovery mode), and an overhead receiving and communication system. The member overboard detection, tracking and recovery system may also include a marking/tracking device, and/or a recovery craft.

### CROSS-REFERENCE TO RELATED APPLICATIONS

This application claims the benefit of U.S. Provisional Application No. 61/601,365 filed Feb. 21, 2012.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### BACKGROUND

The subject matter generally relates to systems and techniques for detection and recovering crew and/or passengers who have fallen overboard from a ship or vessel into a body of water.

### BRIEF SUMMARY

The disclosure relates to systems, methods and apparatus for member or man overboard detection, tracking and recovery used for analyzing conditions on and/or around a ship or vessel located on a body or water. The member overboard detection, tracking and recovery system generally includes the ship, members of the ship, transmitting device, a ship based member overboard detection system, a member overboard (when in the detection, tracking and recovery mode), and an overhead receiving and communication system. The member overboard detection, tracking and recovery system may also include a marking/tracking device, and/or a recovery craft.

### BRIEF DESCRIPTION OF THE SEVERAL VIEWS OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a schematic view of a person overboard detection, tracking and recovery system according to one embodiment.

FIG. 2 depicts a transmitting device according to one embodiment.

FIG. 3 depicts a transmitting device according to another embodiment.

FIG. 4 depicts a transmitting device according to still another embodiment.

FIG. 5 depicts one embodiment of RFID reader.

FIG. 6 depicts one embodiment of a network antenna.

FIG. 7 depicts a schematic elevation view of a ship representing the virtual barrier and zone.

FIG. 8 depicts a schematic elevation view of a ship representing the virtual barrier and zone.

FIG. 9 depicts a schematic top view of a ship representing the virtual barrier and zone and communication network.

FIG. 10 depicts a ship having thermal tracking cameras in one embodiment.

FIGS. 11-14 show various embodiments of thermal tracking cameras.

FIG. 15 represents a schematic view of thermal tracking cameras locking onto a member overboard.

FIG. 16 depicts a block diagram of the member overboard detection, tracking and recovery system including the ship based member overboard detection system.

### DETAILED DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

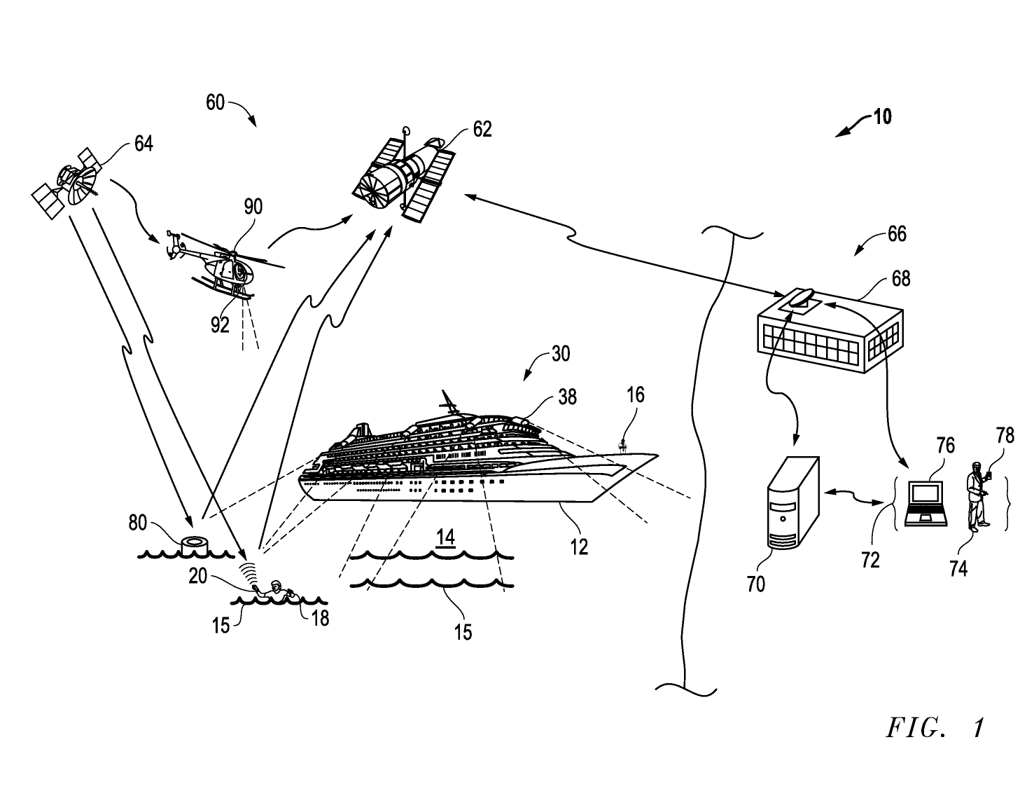

FIG. 1 depicts a schematic view of a member overboard detection, tracking and recovery system 10 according to one embodiment. The member overboard detection, tracking and recovery system 10 may be used for analyzing conditions on and/or around a ship or vessel 12 located on a body or water 14; for analyzing conditions globally including in particular on the surface 15 of the body of water 14 to any distance beyond the ship 12; and for detecting, tracking and recovering a member overboard 18.

The member overboard detection, tracking and recovery system 10 generally includes the ship 12, members of the ship 16, transmitting device 20, a ship based member overboard detection system 30, a member overboard 18 (when in the detection, tracking and recovery mode), and an overhead receiving and communication system 60. The member overboard detection, tracking and recovery system 10 may also include a marking/tracking device 80, and/or a recovery craft 90.

As shown if FIG. 1 the member overboard 18 is shown floating, swimming or drifting along the surface 15 of the body of water 14 after having fallen from the ship 12 (i.e. in what is commonly referred to as a “man overboard” condition). The member overboard 18 is wearing a transmitting device 20. The transmitting device 20 forms a part of the member overboard detection, tracking and recovery system 10. The ship based member overboard detection system 30 detects the member overboard 18 in real time simultaneous with the time that a member of the ship 16 falls off the ship 12 and into the body of water 14.

The members of the ship 16 in the embodiment shown are human crew members and/or passengers, although the members of the ship 16 may also be animals, cargo and/or robotic crew members (all not shown).

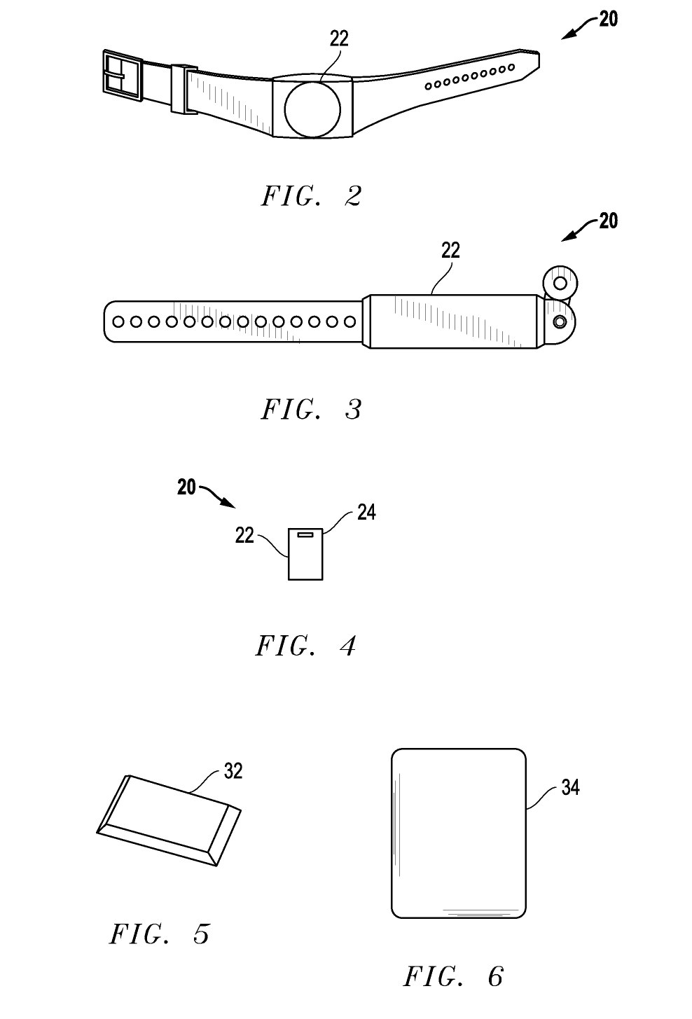

The members of the ship 16 are issued a (mandatory or optional) transmitting device 20 preferably prior to or upon boarding the ship 12. Referring to FIGS. 2-4, the transmitting device 20 may, for example, be a radio frequency identification device 22 (such as a radio frequency identification tag or RFID tag mounted on, for example, a wristband 24). The radio frequency identification device 22 is not limited to wristbands and could, for example, take the form of personnel equipment tags, key fobs, temperature sensors (i.e. activated by water temperature), badges or cards 24 and the like. In the currently preferred embodiment the radio frequency identification device 22 is passive or battery assist passive. The radio frequency identification device 22 may option be used to function for other purposes. By way of example, the radio frequency identification device 22 could also be used for point of sale purchases, keyless entry to rooms and/or lockers, entry to controlled access or security areas, customer loyalty and/or VIP (“very-important-person”) programs, parental controls, and standing watch integrity.

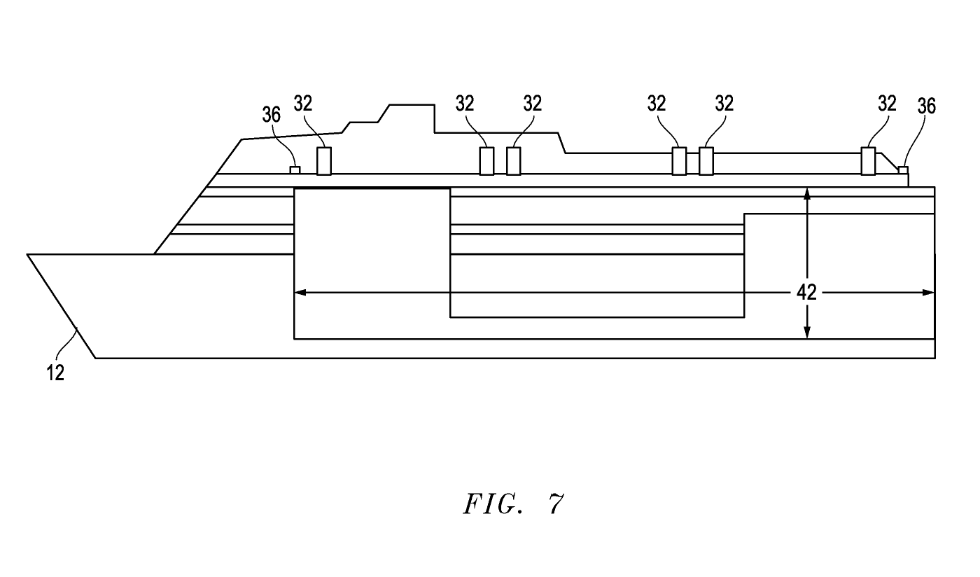

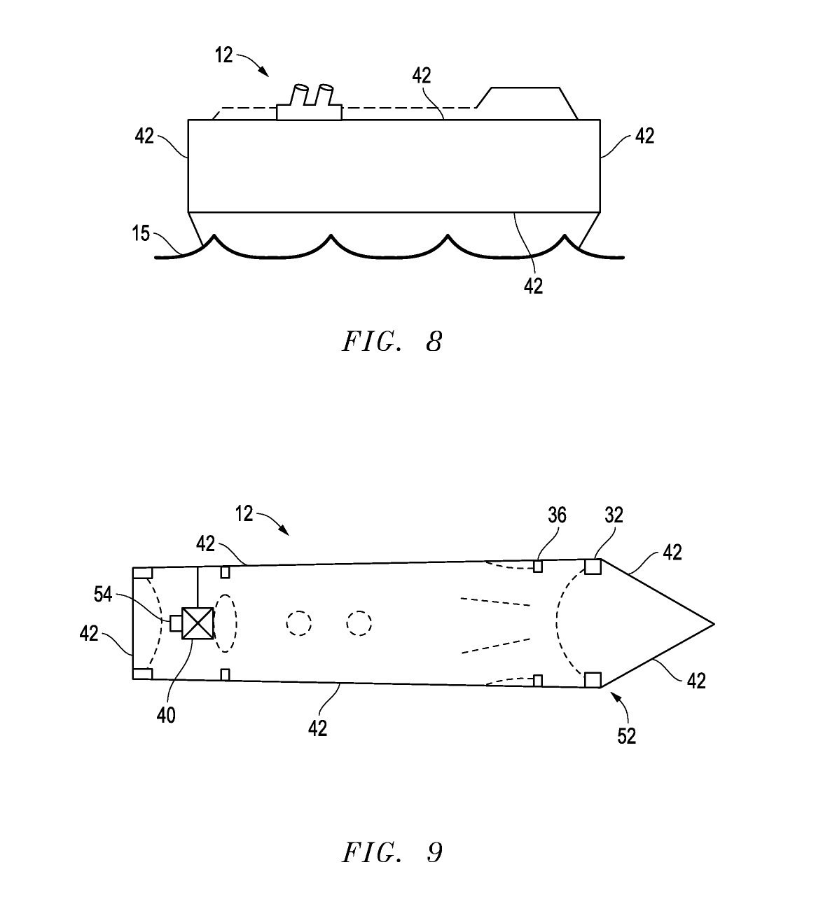

Referring to FIGS. 5-9, the ship based member overboard detection system 30 in the embodiment shown utilizes the transmitting devices 20 or the radio frequency identification devices 22 includes one or more radio frequency identification readers 32 (e.g. Wi-Fi operated), one or more network antennas 34, automatically tracking video cameras 36, thermal tracking cameras 38, and intelligent video analytical software 40 (e.g. software capture images, determining whether a member of the ship 16 has fallen entirely through a virtual barrier thereby raising a discrete alarm and/or activating tracking and recovery). The ship based member overboard detection system 30 includes a communication network 52 and one or more computers 54.

The radio frequency identification readers 32 are combined with the network antennas 34 in the communication network 52 and mounted on the ship 12 around the periphery of the ship 12, and when activated create a virtual barrier and zone 42 for detection of radio frequency identification devices 22. The virtual barrier and zone 42 is continuous around the periphery of the ship 12. By way of example only, an array of radio frequency identification readers 32 and video cameras 36 are mounted around the periphery to create zones, and antennas 34 are mounted proximate lifeboat stations 26. Accordingly, the ship based member overboard detection system 30 is capable of detecting the radio frequency identification devices 22 at any point around the periphery of the ship 12. The virtual barrier and zone 42 also detects to a depth beginning from the top deck 13a and continuing below the lowermost deck 13b of the ship 12 but terminating above the surface 15 of the body of water 14. Accordingly, the ship based member overboard detection system 30 is capable of detecting the radio frequency identification devices 22 that fall through a set or variable distance over a set or variable period of time, or the entire depth of the virtual barrier and zone 42. This aids in preventing false alarms that would otherwise be caused by movement of members of the ship 16 wherein such movement is not due to a member of the ship 16 falling off of the ship 12, i.e. in the currently preferred embodiment a member of the ship 16 does not have to fall through the entire virtual barrier and zone 42 but only a sufficient distance to obtain enough readings to be able to calculate the speed and direction of the movement according to an algorithm (as would be available to one having ordinary skill in the art), such that a member of the ship 16 that meets the requisite combination of time, distance, velocity and/or acceleration conditions will be interpreted as a member overboard event. The distance as used in the computation is dependent to some degree upon class or size of ship (i.e. applicable distance from individual ship deck to surface of the body of water 15). In one working example intended for illustration only, downward travel at greater than ten miles-per-hour for a distance greater than ten feet can be interpreted as a member of the ship 16 or a radio frequency device 22 falling off the ship 12. The time, location, and identity of the member overboard 18 will be immediately or instantaneously determined by the system 30 which is critical to achieving the intended goal(s). Furthermore, by installing antennas at the lifeboat mustering stations 26 the members of the ship 16 may be readily counted during, for, example, a lifeboat drill.

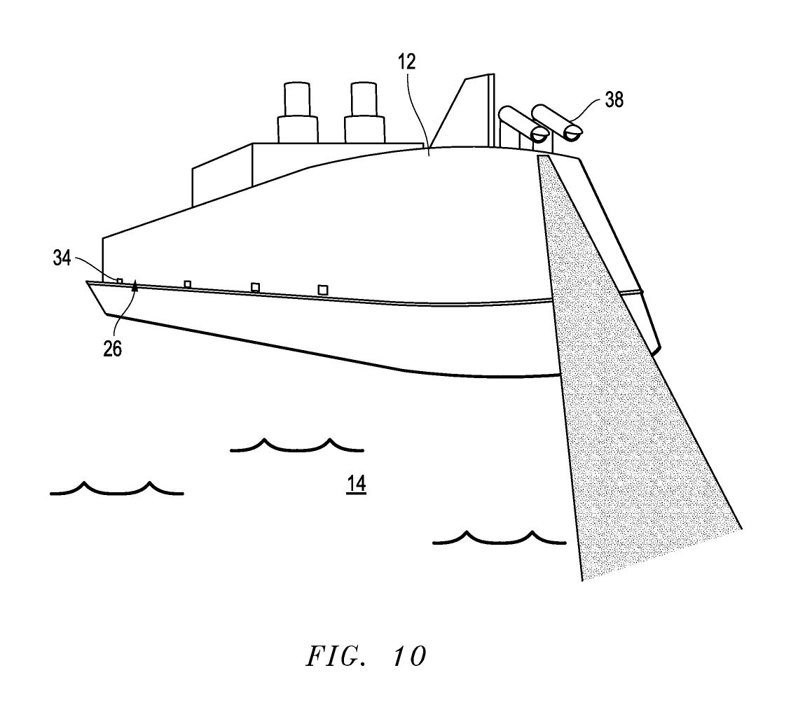

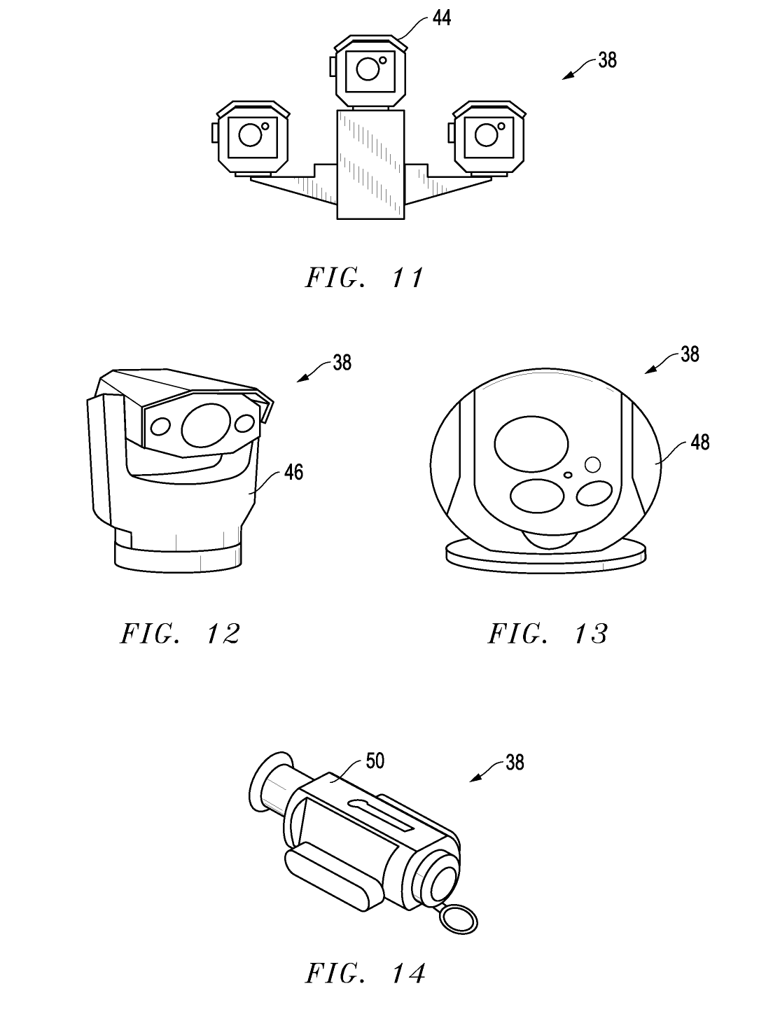

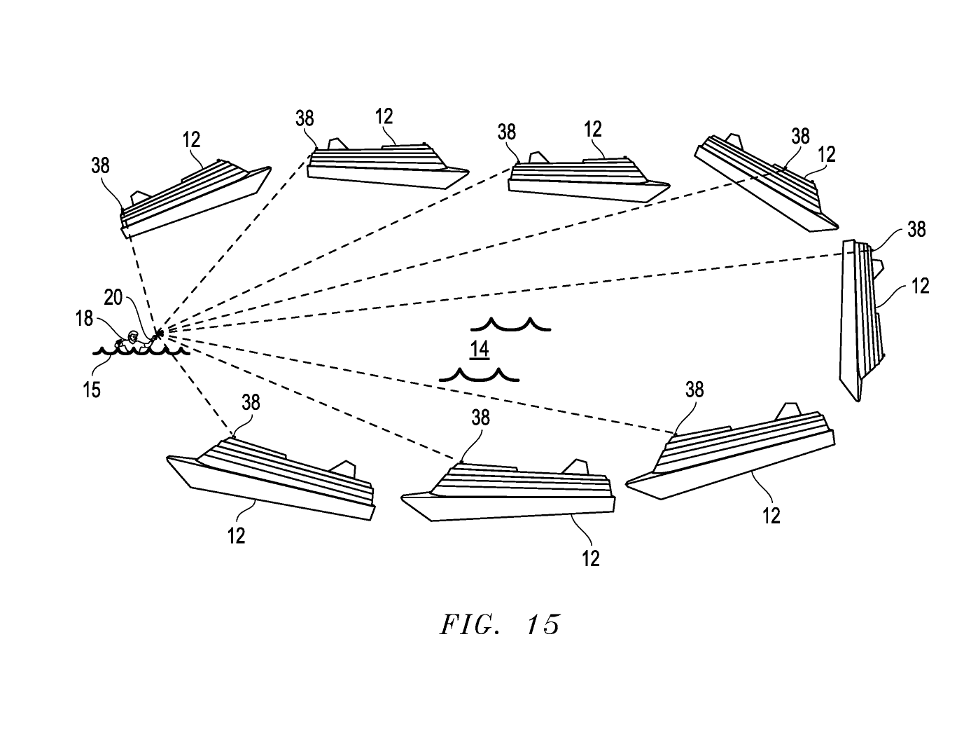

The thermal tracking cameras 38 are mounted on the ship 12 around the periphery (e.g., four total, two port and two starboard) of the ship 12 (see FIG. 10) at various intervals to enable thermal imaging across the surface 15 of the body of water 14 surrounding the ship 14. Referring to FIGS. 11-14, the thermal tracking cameras 38 are preferably long range having thermal tracking ranges up to twenty kilometers in distance away from the camera (by way of example only, the thermal tracking camera 38 could be a laser/thermal video/tracking camera 44 having a five kilometer range, a stabilized thermal video/tracking camera 46 having a one kilometer range, a thermal video/tracking camera 48 having a ten kilometer range). Thermal tracking cameras 38 of differing ranges may be combined on the ship 12. Handheld thermal tracking camera(s) 50 may be used on a recovery craft 90. Preferably, but not limited to, thermal tracking camera(s) 38 should have a range of at least five thousand meters (or dependent upon the mobility and turning radius of a ship 12 or recovery craft 90).

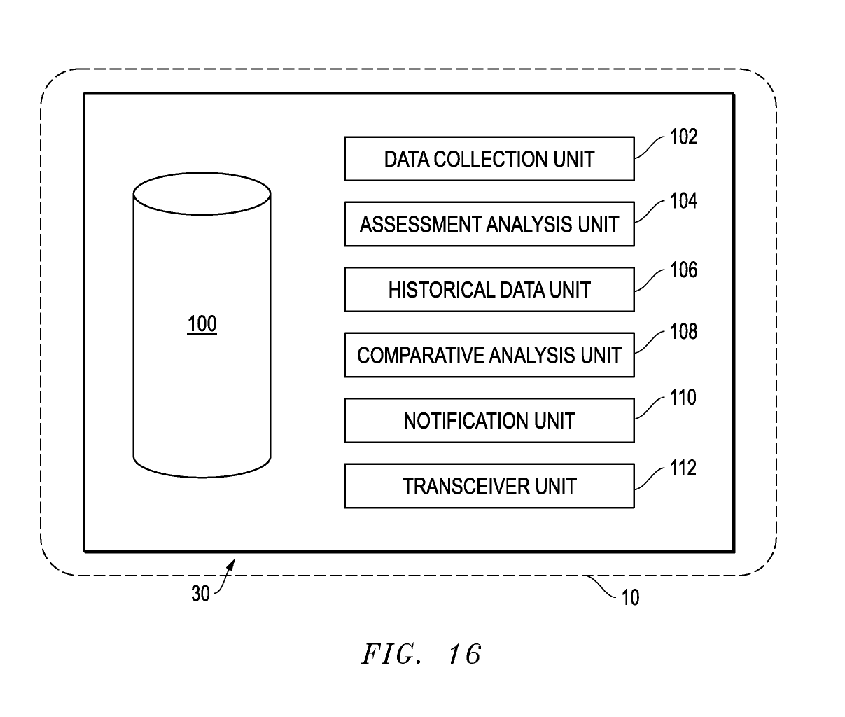

Referring to FIGS. 1 and 7-9, at the time that the member overboard 18 falls through the entire depth of the virtual barrier and zone 42 and is identified by the ship based member overboard detection system 30, global positioning data from the overhead receiving and communication system 60 may be immediately or instantaneously fed into the ship based member overboard detection system 30. Using this data, the thermal tracking cameras 38 may immediately or very nearly instantaneously lock onto the member overboard 18 (see FIG. 15) and continue to adjust and lock onto the member overboard 18 even as the ship 12 moves independently of the member overboard 18. This feature of locking onto the member overboard 18 nearly instantaneously can be critical to a successful rescue effort.

Overhead receiving and communication system 60 in one embodiment encompasses the transmitting device 20 and may include a communication satellite 62, a global-positioning satellite (or “GPS” satellite) 64, and a communication network 66. In one embodiment the communication network has a gateway 68, one or more computers or servers 70, and may include a service company (or the coast guard) 72 having worker(s) (optionally rescue worker(s)) 74 having their own computers 76, handheld (or other data input) devices 78 meaning any suitable data input devices including, but not limited to, a tablet computer, a personal digital assistant, a smart phone, a laptop, a desktop, any suitable data input device described herein and the like. The communication network may be located on the ship 12, on another ship(s) 12, on dry land, or on a combination of the foregoing. It is to be understood as used herein, the terms “transmit”, “transmitter”, “receive”, “receiver” may be interchangeable or transmitting and receiving may be integrated into a single component as would be available to one having ordinary skill in the art. By way of example only to serve as an illustration, the transmitting device 20 could be a handheld device 78 (e.g. a “Smartphone”) serving as a receiver in a communication network designed to accommodate the handheld device 78 for the purposes expressed herein.

The marking/tracking device 80 may be placed in the body of water as close as possible to the member overboard event to track the drift or current. The marking/tracking device may be turned on, is buoyant and may be dropped into the body of water 14 at a height above the surface 15. The marking/tracking device 80 may be battery powered to last, for example, up to twenty-one days. The marking/tracking device may function as a transmitter for transmitting data to the overhead receiving and communication system 60.

A recovery craft 90 may be implemented into the member overboard detection, tracking and recovery system 10. The recovery craft 90 may be air or water based and may or may not be launched from the ship 12. GPS data may be transmitted to the recovery craft from the overhead receiving and communication system 60. In one embodiment the recovery craft 90 comprises a drone helicopter that includes a light and/or thermal camera (i.e. a thermal video and/or visible light array 92) to lock onto the member overboard 18.

Although several data collection systems, methods and/or devices are described it should be appreciated that any suitable data collection systems, methods and/or devices may be used.

The computer(s) 54, 70, 76 and/or 78 may be a traditional desktop computer, or any other suitable computer including, but not limited to, a tablet, a laptop, a personal digital assistant and the like. The communication network 52 may be any suitable system for relaying data about the ship based member overboard detection system 30 including those described herein. The communication network 52 may include wires, wireless communication, acoustic communication, telemetry tools, and the like. The communication network 52 may be limited to relaying information about the ship based member overboard detection system 30. In an alternative embodiment, the communication network 52 may include an internet, or cloud communication network, combined with the communication network 66 and/or the overhead receiving and communication system 60. The communication networks 52, 66 and/or the overhead receiving and communication system 60 may be any suitable network including those described herein.

FIG. 16 depicts a schematic view of the member overboard detection, tracking and recovery system 10 including the ship based member overboard detection system 30 according to an embodiment. The member overboard detection, tracking and recovery system 10 may have a storage device 100, a data collection unit 102, an assessment analysis unit 104, a historical data unit 106, a comparative analysis unit 108, a notification unit 110, and a transceiver unit 112. The storage device 100 may be any suitable storage device for storing data. The transceiver unit 112 may be any suitable device configured to send and/or receive data to the member overboard detection, tracking and recovery system 10 including the ship based member overboard detection system 30.

The data collection unit 102 may collect, manipulate, and/or categorize the data collected by the radio frequency identification readers 32, the one or more network antennas 34, the automatically tracking video cameras 36, the thermal tracking cameras 38, and more broadly any data collected by the communication network 52, the communication network 66 and/or the overhead receiving and communication system 60. The data collected may include any of the real time details of any and all of the transmitting devices 20 on and/or off the ship 12. Further, the data collected may be any suitable data that can be collected from any suitable sensor including those described herein, laser scanners, acoustic tools, cameras, GPS devices, surveying equipment, water condition sensors, vessel structure conditions, relative experience of members of the crew, and the like. The data collection unit 102 may manipulate the collected data into a format that allows the operator and/or the member overboard detection, tracking and recovery system 10 to take appropriate action during the operations as discussed herein.

The assessment analysis unit 104 may receive the categorized data from the data collection unit 102 in order to tabulate and/or determine if there is any present or future risk likely at the ship 12 and/or in the body of water 14. The risk may be based on real time events that are taking place in the operations and/or based on predictive events that are likely to occur. The assessment analysis unit 104 may classify the risks for ship 12.

The historical data unit 106 may categorize the historical data collected by the data collection unit 102. Further, the historical data unit 106 may categorize historical known data from the area around the ship 12 such as geological factors, weather patterns and the like.

The comparative analysis unit 108 may compare the data collected by the data collection unit 102, the classified risks, and/or the historical data in order to determine a course of action for any operator and/or recovery craft 90. The comparative analysis unit 108 may further determine if the operations of the virtual barrier and zone 42 are within a predetermined set of parameters. For example, should any one of the radio frequency identification devices 22 fall through the entire depth of the virtual barrier and zone 42 the comparative analysis unit 108 may compare the parameters to detect this condition or, in the alternative, to ensure that all radio frequency identification devices 22 are within the parameter. The parameters may be any suitable parameters set by the ship company, regulatory agency, or any other suitable source. The comparative analysis unit 108 may make a determination of how serious the risk is based on the data collected. The comparative analysis unit 108 may relay information to the notification unit 110 so that the notification unit 110 may alert any operator, any recovery craft 90 and/or take action. The comparative analysis unit 108 may use an algorithm developed to approximate or predict location of a member overboard 18 and may include data gathered by the GPS satellite 64 and/or the marking/tracking device 80.

The notification unit 110 may alert any operator of a real time condition, and/or a predicted condition about the ship 12. The notification unit 110 may alert the operator via a discrete alarm, a visual display, an audible sound (such as an alarm), a kinetic or automated response, and/or a combination thereof. The notification unit 110 may transmit an alarm to a shore based facility (such as the service company and/or coast guard 72) via the communication network(s) which may include communication satellite 62. The notification unit 110 may create or enable an implementation plan. The implementation plan may include, but is not limited to tracking and/or recovery plans and schedules, maintenance plans and schedules, mitigation plans and schedules for any of the components of the member overboard detection, tracking and recovery system 10. Further, the notification unit 110 may take preventative action to prevent further risk to members of the ship 16 and/or the personnel. F or example, the notification unit 110 may notify members of the ship 16 of impending perilous weather conditions, to move to lifeboat mustering areas, and/or to remain within confined areas in the event of some accident or condition.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any assessment used for structures, bridges, refineries, industrial sites, and the like.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A member overboard detection, tracking and recovery system for use with a ship in a body of water in the event of a member overboard, comprising:
a transmitting device to be worn by any member of the ship; and
a ship based member overboard detection system.

2. The member overboard detection, tracking and recovery system of claim 1, further comprising an overhead receiving and communication system in communication with the transmitting device and with the ship based member overboard detection system.

3. The member overboard detection, tracking and recovery system of claim 2, further comprising a marking and tracking device placed in the body of water; and wherein the marking and tracking device is in communication with the overhead receiving and communication system.

4. The member overboard detection, tracking and recovery system of claim 1, further comprising a recovery craft within the region of the body of water.

5. The member overboard detection, tracking and recovery system of claim 1, wherein said ship based member overboard detection system comprises:
a radio frequency identification reader mounted on the ship;
a network antenna mounted on the ship;
an automatically tracking video camera mounted on the ship;
a thermal tracking camera mounted on the ship;
a computer and a communication network in communication with the radio frequency identification reader, the automatically tracking video camera, and the thermal tracking camera; and
wherein the computer is configured for determining a speed and a direction of movement of the member of the ship for determining whether the member of the ship has fallen entirely through a virtual barrier thereby activating a response.

6. The member overboard detection, tracking and recovery system of claim 5, further comprising an overhead receiving and communication system in communication with the transmitting device and with the ship based member overboard detection system;
wherein the overhead receiving and communication system further comprises:
a communication satellite, a global-positioning satellite, and another communication network; and
wherein the other communication network includes a service company and a data input device.

7. The member overboard detection, tracking and recovery system of claim 5, wherein the ship based member overboard detection system comprises:
a data collection unit configured to collect data from the transmitting device, the radio frequency identification reader, the network antenna, the automatically tracking video camera, and the thermal tracking camera;
a comparative analysis unit configured to include a predetermined set of parameters to, at least in part, determine the virtual barrier, and configured to compare the data from the data collection unit in order to predict whether the transmitting device is in the body of water; and
a notification unit configured to alert an operator based on the compared data from the comparative analysis unit.

8. The member overboard detection, tracking and recovery system of claim 7, wherein the ship based member overboard detection system further comprises:
a storage device unit configured to store data collected from the data collection unit;
a historical data unit configured to categorize historical data from the data collection unit and the storage device unit and environmental data from an area around the ship and the body of water;
an assessment analysis unit configured to classify and determine a risk of the ship in the body of water based on data from the data collection unit, the storage device unit, and the historical data unit; and
a transceiver unit configured to send and receive data to and from the ship based member overboard detection system and the overhead receiving and communication system.

9. A member overboard detection, tracking and recovery system for use with a ship in a body of water in the event of a member overboard, comprising:
a plurality of transmitting devices to be worn by any members of the ship;
a ship based member overboard detection system;
wherein said ship based member overboard detection system comprises:
a plurality of radio frequency identification readers mounted around a periphery of the ship;
a plurality of network antennas mounted around the periphery of the ship;
a plurality of tracking cameras mounted around the periphery of the ship;
a computer and a communication network in communication with the radio frequency identification readers, and said tracking cameras; and
wherein the computer is configured for determining a speed and a direction of movement of the member of the ship for determining whether the member of the ship has fallen off the ship thereby activating a response; and
an overhead receiving and communication system in communication with the transmitting device and with the ship based member overboard detection system.

10. The member overboard detection, tracking and recovery system of claim 9, wherein said plurality of tracking cameras comprises a plurality of automatically tracking video cameras.

11. The member overboard detection, tracking and recovery system of claim 10, wherein said plurality of tracking cameras further comprises at least one handheld thermal tracking camera held on the ship.

12. The member overboard detection, tracking and recovery system of claim 8, wherein the ship includes a plurality of decks; and
wherein the plurality of radio frequency identification readers, the plurality of network antennas, and said plurality of tracking cameras are not all mounted on the same deck of the ship.

13. The member overboard detection, tracking and recovery system of claim 8, wherein the overhead receiving and communication system further comprises another communication network, wherein the other communication network includes a data input device.

14. The member overboard detection, tracking and recovery system of claim 8, wherein the overhead receiving and communication system further comprises:
a communication satellite, a global-positioning satellite, and another communication network; and
wherein the other communication network includes a service company and a data input device.

15. A method for detecting, tracking and recovering a member overboard for use with a ship in a body of water, comprising the steps of:
transmitting data from any member of the ship; and
detecting the data with a ship based member overboard detection system.

16. The method according to claim 15, further comprising the step of receiving and communicating the data with an overhead receiving and communication system.

17. The method according to claim 16, further comprising the step of marking and tracking the data with a marking and tracking device placed in the body of water, wherein the marking and tracking device is in communication with the overhead receiving and communication system.

18. The method according to claim 16, further comprising the step of recovering any member overboard with a recovery craft within the region of the body of water.

19. The method according to claim 16, further comprising the steps of:
collecting the transmitted data and the detected data;
predetermining a set of parameters for determining a virtual barrier;
comparing the transmitted and detected data to the virtual barrier; and
notifying an operator based on the results of said step of comparing the transmitted and detected data to the virtual barrier.

20. The method according to claim 15, further comprising the step of calculating a speed and a direction of the movement the member of the ship based on the detected data.
